(19) United States
(12) Patent Application Publication
(10) Pub. No.: US 2026/0105614 A1
(43) Pub. Date: Apr. 16, 2026

(54) ARTIFICIAL INTELLIGENCE MODELING TECHNIQUES FOR JOINT BEHAVIOR PLANNING AND FORECASTING

(71) Applicant: Tesla, Inc., Austin, TX (US)

(72) Inventors: Ashok Kumar ELLUSWAMY, Austin, TX (US); Paril JAIN, Austin, TX (US); Daniel KUREK, Austin, TX (US); Dhiral CHHEDA, Austin, TX (US); Matthew BAUCH, Austin, TX (US); Christopher PAYNE, Austin, TX (US); Micael CARVALHO, Austin, TX (US)

(73) Assignee: Tesla, Inc., Austin, TX (US)

(21) Appl. No.: 19/116,300

(22) PCT Filed: Sep. 29, 2023
(86) PCT No.: PCT/US2023/075626

§ 371 Date: Mar. 27, 2025

Related U.S. Application Data
(60) Provisional application No. 63/377,954, filed on Sep. 30, 2022.
(60) Provisional application No. 63/378,028, filed on Sep. 30, 2022.

(51) Int. Cl. G06T 7/20

(52) U.S. Cl. CPC G06T 7/20; G06T 2207/20072; G06T 2207/20084; G06T 2207/30241; G06T 2207/30252

(57) ABSTRACT

A method comprises detecting one or more agent objects in a space around an ego object using image data captured by a camera of the ego object; storing a hierarchical nodal graph comprising a goal layer comprising one or more goal nodes and a plurality of interaction layers of interaction nodes subsequent to the goal layer; adding an interaction node to an interaction layer of interaction nodes of the plurality of interaction layers; determining a trajectory score for each of a plurality of trajectories based on one or more node scores of one or more nodes corresponding to the trajectory within the hierarchical nodal graph; and selecting a trajectory of the plurality of trajectories for the ego object based on the trajectory score for the trajectory.

### CROSS-REFERENCE TO RELATED PATENT APPLICATIONS

The present application claims priority to U.S. Provisional Application No. 63/377,954, filed Sep. 30, 2022, and U.S. Provisional Application No. 63/378,028, filed Sep. 30, 2022, each of which is incorporated herein by reference in its entirety for all purposes.

### TECHNICAL FIELD

The present disclosure generally relates to artificial intelligence-based modeling techniques to select a suitable trajectory for an ego.

### BACKGROUND

Autonomous navigation technology used for autonomous vehicles and robots (collectively, egos) has become ubiquitous due to rapid advancements in computer technology. These advances allow for safer and more reliable autonomous navigation of egos. Egos often need to navigate through complex and dynamic environments and terrains that may include vehicles, traffic, pedestrians, cyclists, and various other static or dynamic obstacles. Understanding the egos'surroundings is necessary for informed and competent decision-making to avoid collisions.

### SUMMARY

For the aforementioned reasons, there is a desire for methods and systems that can analyze an ego's surroundings and select trajectories that avoid collisions with objects in the ego's surroundings. A system (e.g., a computing system of an ego) implementing the systems and methods herein can do so using a hierarchical nodal graph with layers of interaction nodes that represent potential interactions or non-interactions with one or more agent objects that the system detects in the ego's surrounding environment. The system can generate scores for the respective interaction nodes of the hierarchical nodal graph based on different variables, such as physics-based constraints, comfortability, intervention likelihood, and/or a human-like discriminator. The system can combine scores for an individual node to determine a score for the node. The system can identify trajectories represented by the hierarchical nodal graph. The trajectories can each include a different variation of interaction nodes of different layers and be linked to each other within the hierarchical nodal graph. The system can generate trajectory scores for the trajectories based on the node scores of the interaction nodes of the respective trajectories, such as by executing a function on the respective node scores of the respective trajectories. The system can compare the trajectory scores between each other to select a trajectory with the highest trajectory score. The system can use the selected trajectory to operate the ego. This process can greatly simplify trajectory selection techniques to enable an ego to make quicker decisions using less processing power than conventional techniques that may attempt to determine possible trajectories for the objects in the surrounding environment, which can require a significant amount of processing resources on a busy street.

In one embodiment, a method comprises detecting, by a processor, one or more agent objects in a space around an ego object using image data captured by a camera of the ego object; storing, by the processor, a hierarchical nodal graph comprising: a goal layer comprising one or more goal nodes corresponding to goals for the ego object to accomplish; a plurality of interaction layers of interaction nodes subsequent to the goal layer, each interaction node corresponding to at least one of a plurality of trajectories for the ego object in view of the one or more agent objects and corresponding to a node score, the plurality of interaction layers comprising an initial interaction layer of interaction nodes and a plurality of subsequent interaction layers of interaction nodes subsequent to the initial interaction layer of interaction nodes, wherein each interaction node in the plurality of subsequent interaction layers depends from at least one interaction node in a previous interaction layer of the plurality of interaction layers; responsive to determining a node score of a first interaction node in the initial interaction layer of interaction nodes exceeds a threshold, adding, by the processor, a second interaction node to a subsequent interaction layer of interaction nodes of the plurality of subsequent interaction layers, the second interaction node linked to the first interaction node; determining, by the processor, a trajectory score for each of the plurality of trajectories based on one or more node scores of one or more nodes corresponding to the trajectory; and selecting, by the processor, a trajectory of the plurality of trajectories for the ego object based on the trajectory score for the trajectory.

The method may further comprise controlling, by the processor, the ego object according to the selected trajectory.

Determining the trajectory score for the trajectory may comprise aggregating, by the processor, the one or more node scores of the one or more nodes of the trajectory.

Selecting the trajectory may comprise selecting, by the processor, the trajectory responsive to determining the trajectory score for the trajectory is higher than trajectory scores of other trajectories of the plurality of trajectories.

The method may comprise executing, by the processor, a neural network to determine the node score for each interaction node of the hierarchical nodal graph.

The node score for each interaction node may correspond to a comfortability associated with the interaction node.

The node score for each interaction node may correspond to a comfortability associated with the interaction node and a likelihood of intervention associated with the interaction node.

The method may further comprise generating, by the processor, the hierarchical nodal graph responsive to detecting the one or more agent objects in the space around the ego object using image data captured by a camera of the ego object.

The method may further comprise executing, by the processor, an analytical protocol to determine the node score for each interaction node of the hierarchical nodal graph; comparing, by the processor, the node scores to a threshold; and removing, by the processor, each interaction node of the hierarchical nodal graph from the hierarchical nodal graph that corresponds to a node score that is less than the threshold.

The method may further comprise responsive to determining that adding the second interaction node to the subsequent layer of interaction nodes of the plurality of subsequent layers causes a number of nodes of the hierarchical nodal graph to exceed a threshold, removing, by the processor, a third node from the hierarchical nodal graph based on a node score for the third node.

In another embodiment, an ego object may comprise a camera; a processor; and a non-transitory computer-readable medium configured to be executed by the processor. The processor can be configured to detect, one or more agent objects in a space around an ego object using image data captured by the camera; store a hierarchical nodal graph comprising: a goal layer comprising one or more goal nodes corresponding to goals for the ego object to accomplish; a plurality of interaction layers of interaction nodes subsequent to the goal layer, each interaction node corresponding to at least one of a plurality of trajectories for the ego object in view of the one or more agent objects and corresponding to a node score, the plurality of interaction layers comprising an initial interaction layer of interaction nodes and a plurality of subsequent interaction layers of interaction nodes subsequent to the initial interaction layer of interaction nodes, wherein each interaction node in the plurality of subsequent interaction layers depends from at least one interaction node in a previous interaction layer of the plurality of interaction layers; responsive to determining a node score of a first interaction node in the initial interaction layer of interaction nodes exceeds a threshold, add a second interaction node to a subsequent interaction layer of interaction nodes of the plurality of subsequent interaction layers, the second interaction node linked to the first interaction node; determine a trajectory score for each of the plurality of trajectories based on one or more node scores of one or more nodes corresponding to the trajectory; and select a trajectory of the plurality of trajectories for the ego object based on the trajectory score for the trajectory.

The processor can be further configured to control the ego object according to the selected trajectory.

The processor can be configured to determine the trajectory score for the trajectory by aggregating the one or more node scores of the one or more nodes of the trajectory.

The processor can be configured to select the trajectory by selecting the trajectory responsive to determining the trajectory score for the trajectory is higher than trajectory scores of other trajectories of the plurality of trajectories.

The processor can be further configured to execute a neural network to determine the node score for each interaction node of the hierarchical nodal graph.

The node score for each interaction node may correspond to a comfortability associated with the interaction node.

The node score for each interaction node may correspond to a comfortability associated with the interaction node and a likelihood of intervention associated with the interaction node.

The processor may be further configured to generate the hierarchical nodal graph responsive to detecting the one or more agent objects in the space around the ego object using image data captured by a camera of the ego object.

The processor can be further configured to execute an analytical protocol to determine the node score for each interaction node of the hierarchical nodal graph; compare the node scores to a threshold; and remove each interaction node of the hierarchical nodal graph from the hierarchical nodal graph that corresponds to a node score that is less than the threshold.

The processor can be further configured to responsive to determining that adding the second interaction node to the subsequent layer of interaction nodes of the plurality of subsequent layers causes a number of nodes of the hierarchical nodal graph to exceed a threshold, removing, by the processor, a third node from the hierarchical nodal graph based on a node score for the third node.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system, according to an embodiment.

FIG. 1B illustrates various sensors associated with an ego, according to an embodiment.

FIG. 1C illustrates the components of a vehicle, according to an embodiment.

FIG. 2 illustrates a flow diagram of a process executed in an AI-enabled visual data analysis system, according to an embodiment.

FIG. 3 illustrates a roadway scenario, according to an embodiment.

FIGS. 4A-E illustrate a hierarchical nodal graph for a roadway scenario, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

An ego (e.g., an autonomous vehicle, such as a car, truck, bus, motorcycle, all-terrain vehicle, cart, a robot, or other automated device) driving on the road must constantly monitor the ego's surroundings for other objects on the road. The ego (e.g., a processor of the ego) may detect different objects, such as pedestrians, other vehicles, or animals and encounter a scenario where the ego has to drive around the objects to reach a desired destination or a desired goal, such as turning left into a far right lane as a pedestrian is crossing the road. In such a scenario, the ego may navigate around the pedestrian by determining different potential trajectories for the pedestrian and any other objects in the area and potential trajectories for the ego. The ego may analyze each of the potential trajectories using an optimization function to determine a trajectory for the ego to accomplish the goal of turning left into the far right lane while avoiding the pedestrian. This can take a large amount of processing power and time to make the decision given the large number of variables that are involved. An ego may perform such decisions many times every second (e.g., every 50 milliseconds) to autonomously navigate the road. Accordingly, an autonomous ego may use a large amount of processing power, and therefore energy and time, making decisions regarding how to navigate the roadway. Using this processing power over time can cause the ego to arrive at destinations late and use an increased amount of energy.

An ego or system implementing the systems and methods described herein may overcome the aforementioned technical deficiencies. For example, a processor of a system or ego may implement a hierarchical nodal graph that includes layers of different nodes for a scenario that the ego encounters. The hierarchical nodal graph can include goal nodes that correspond to goals for the ego to accomplish (e.g., avoid a pedestrian, reach a target lane or parking spot, etc.) and interaction nodes that correspond to interactions and/or non-interactions between the ego and agent objects (e.g., objects that are moving or may move in the environment around the ego). Examples of interactions can include the ego passing in front of or behind the agent objects or contacting the agent object, but interactions do not require contact with the agent object. Examples of non-interactions can include the ego performing an action to avoid the agent objects altogether. The processor can identify such nodes in the hierarchical nodal graph for the ego and agent objects that the ego detects using a camera of the ego. The processor can determine a score for each of the interaction nodes and/or the goal nodes based on intervention likelihood (e.g., human intervention likelihood), a human-like discriminator, and/or physics-based constraints of the respective interaction node or goal node. The processor can identify different trajectories of a hierarchical nodal graph that each include a goal node and one or interaction nodes in sequential order within the hierarchical nodal graph. The processor can determine a trajectory score for each trajectory. The processor can select a trajectory that corresponds to the highest trajectory score. The processor can use the selected trajectory to control the ego. In this way, the ego can determine an optimal trajectory for the ego without determining trajectories of objects in the surrounding environment or using complex cost functions, reducing the processing costs and time of selecting trajectories to use for autonomous driving.

The hierarchical nodal graph can have hierarchical layers of nodes. The processor can use the hierarchical configuration of the layers to determine how to traverse the hierarchical nodal graph to determine potential trajectories to use to control the ego. For example, the hierarchical nodal graph can include a goal layer that includes one or more goal nodes. The goal nodes can each be the beginning of one or more trajectories for the ego. Next, the hierarchical nodal graph can include multiple interaction layers, an initial interaction layer and one or more subsequent interaction layers. Each interaction layer can include one or more interaction nodes. The interaction nodes of the initial interaction layer can each be linked to at least one goal node. The interaction nodes of the first subsequent interaction layer can each be linked to at least one interaction node in the initial interaction layer. The interaction nodes in the subsequent interaction layers to the first subsequent interaction layer can each be linked to at least one interaction node in the prior interaction layer. The processor can use the links between the nodes to traverse different trajectories and combine scores of the interaction nodes and/or the goal nodes of the trajectories to select a trajectory for the ego.

To avoid generating a hierarchical nodal graph that is too large and may require a large amount of computing resources to maintain and evaluate different trajectories, the processor can prune the hierarchical nodal graph over time. For example, the processor can compare node scores of the nodes of the hierarchical nodal graph to a threshold. Responsive to determining a node score of a node is less than the threshold, the processor can remove the node from the hierarchical nodal graph. In one example, the processor can remove a node with an undesirable trait, such as the ego contacting an object, to avoid using processing resources for trajectories that the processor would not select. The processor can remove such nodes and expand on other higher scoring nodes over time to maintain a hierarchical nodal graph that the processor can use to efficiently control the ego.

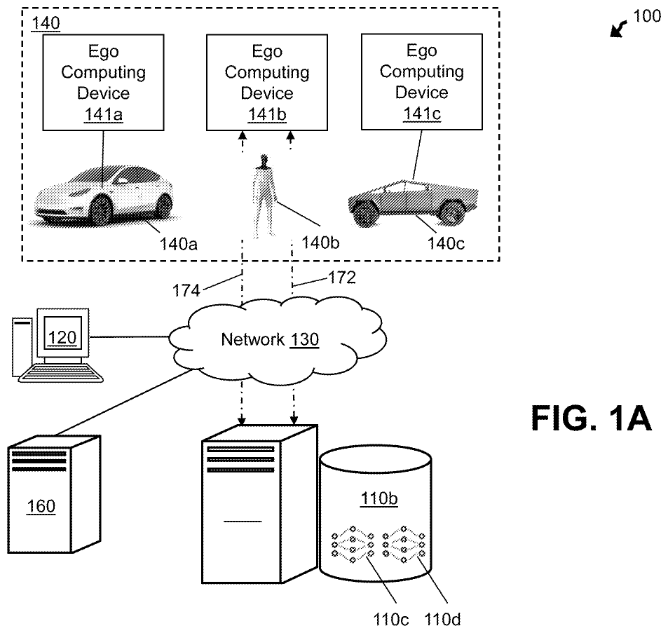

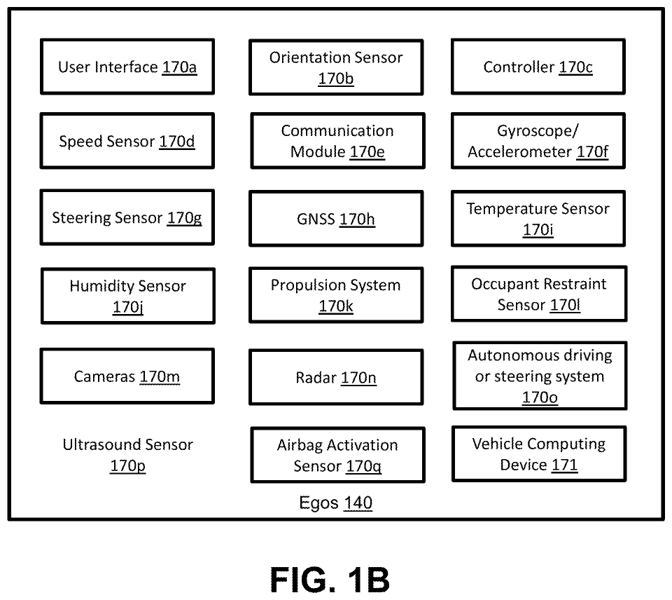

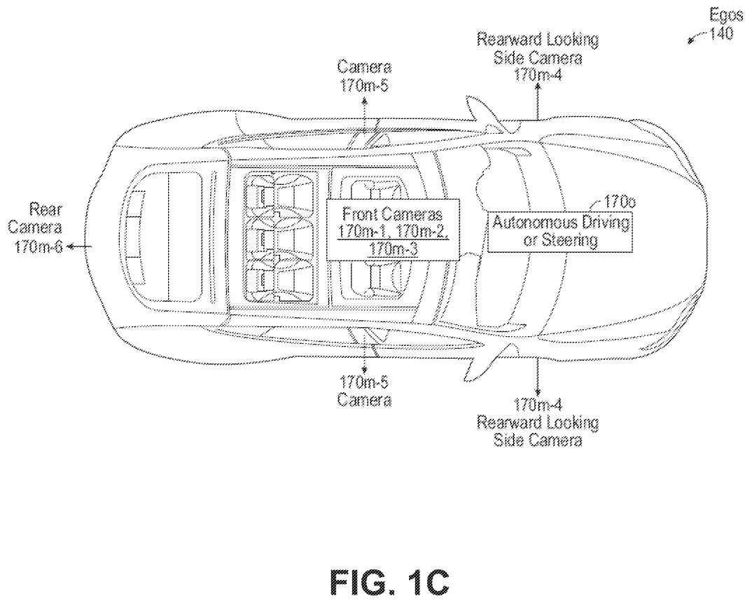

FIG. 1A is a non-limiting example of components of a system in which the methods and systems discussed herein can be implemented. FIG. 1A illustrates components of an artificial intelligence (AI)-enabled visual data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to implement one or more AI models, such as the AI model(s) 110c, and a hierarchical nodal graph 110d. Specifically, as depicted in FIG. 1A and described herein, the analytics server 110a can use the methods discussed herein to generate and use a hierarchical nodal graph 110d for autonomous navigation using data retrieved from the egos 140 (e.g., by using data streams 172 and 174). In one example, the AI model(s) 110c can detect the occupancy of different voxels representing the area surrounding an ego 140 based on image data captured by a camera of the ego 140. Based on the occupancy data, the analytics server 110a or the ego 140 can detect different agent objects (e.g., moving objects) in the area surrounding the ego 140. The ego 140 or the analytics server 110a can use the detected agent objects to generate the hierarchical nodal graph 110d to include goal nodes and/or interaction nodes. The goal nodes can indicate individual goals for the ego 140 to accomplish and the interaction nodes can indicate potential interactions or non-interactions between the ego 140 and the agent objects or between the agent objects themselves. The ego 140 or the analytics server 110a can generate node scores for the nodes of the hierarchical nodal graph 110d. The ego 140 can use the node scores to generate trajectory scores for different trajectories that include different variations of linked nodes within the hierarchical nodal graph 110d. The ego 140 can select a trajectory based on the trajectory score of the trajectory (e.g., based on the trajectory having a highest trajectory score). The ego 140 can autonomously operate according to the selected trajectory. Therefore, the system 100 depicts a method of navigation using a hierarchical nodal graph that is faster and requires fewer processing resources than conventional methods of trajectory generation and/or selection.

In FIG. 1A, the AI model 110c and the hierarchical nodal graph 110d are illustrated as components of the system database 110b, but the AI model 110c and the hierarchical nodal graph 110d may be stored in a different or a separate component, such as cloud storage or any other data repository accessible to the analytics server 110a or the egos 140.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to generate the hierarchical nodal graph 110d. For instance, a driver for the vehicle 140a may authorize the analytics server 110a to monitor data associated with their respective vehicle. As a result, the analytics server 110a may utilize various methods discussed herein to collect sensor/camera data and detect agent objects in the environments of the egos 140 that collect the sensor/camera data. The analytics server 110a can gradually build the hierarchical nodal graph 110d from the data by adding goal nodes and interaction nodes linked to each other in a sequence of layers from different scenarios for which the egos 140 provide the data. The analytics server 110a can generate node scores for the different nodes and prune out nodes with low node scores or node scores that are otherwise below a threshold. The analytics server 110a can deploy or transmit the hierarchical nodal graph to the different egos 140 for use in autonomous driving.

As time goes on the egos 140 can transmit further data regarding different scenarios to the analytics server 110a. The analytics server 110a can update the hierarchical nodal graph 110d based on the data over time and transmit updated versions of the hierarchical nodal graph 110d to the egos 140 to use for autonomous driving. Therefore, the system 100 depicts a loop in which navigation data received from the egos 140 can be used to update the hierarchical nodal graph 110d. The egos 140 may include processors that process the hierarchical nodal graph 110d for navigational purposes (e.g., to select trajectories to use for navigation).

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-C illustrate block diagrams of sensors integrated within the egos 140, according to an embodiment. The number and position of each sensor discussed with respect to FIGS. 1B-C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to generate the hierarchical nodal graph 110d and/or execute the AI model 110c to generate an occupancy map to detect agent objects in the space around the ego 140. Moreover, the hierarchical nodal graph 110d and/or execute the AI model 110c can generate a trajectory recommendation for the egos 140.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, the communication module 170e may be implemented in a distributed manner such that portions of the communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as the controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 1701 may monitor seatbelt detection and locking/unlocking assemblies, as well as other passenger restraint subsystems. The occupant restraint sensor 1701 may include various environmental and/or status sensors, actuators, and/or other devices facilitating the operation of safety mechanisms associated with the operation of the egos 140. For example, occupant restraint sensor 1701 may be configured to receive motion and/or status data from other sensors depicted in FIG. 1B. The occupant restraint sensor 1701 may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior-or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 170o configured to use data collected via various sensors (e.g., radar 170n, speed sensor 170d, and/or ultrasound sensors 170p) to autonomously navigate the ego 140.

Therefore, autonomous driving or steering system 170o may analyze various data collected by one or more sensors described herein to identify driving data. For instance, autonomous driving or steering system 170o may calculate a risk of forward collision based on the speed of the ego 140 and its distance to another vehicle on the road. The autonomous driving or steering system 170o may also determine whether the driver is touching the steering wheel. The autonomous driving or steering system 170o may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c and/or the generation of the hierarchical nodal graph 110d maintained by the analytics server 110a and/or the individual egos 140.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how an ego computing device 141 of an ego 140 can generate and/or use the hierarchical nodal graph 110d for navigation, as the ego computing device 141 controls the ego 140 for autonomous driving, cameras of the ego 140 can generate image data of the space around the ego 140. The ego computing device 141 can execute the AI model(s) 110c to automatically detect agent objects in the space, such as by generating and analyzing different voxels representing the space for occupancy characteristics from the image data. The ego computing device 141 can determine a task for the ego 140 to perform, such as to perform a left turn. Responsive to determining the task, the ego computing device 141 can generate or use the hierarchical nodal graph 110d to determine a trajectory to use to control the ego 140 to perform the task.

For example, to generate the hierarchical nodal graph 110d, the ego computing device 141 can generate one or more goal nodes that correspond with the task. The goal nodes can correspond to different goals or targets for the task, such as to perform the left turn, to perform the left turn safely, to avoid exceeding a specific speed, etc. The ego computing device 141 can generate one or more interaction nodes. The interaction nodes can correspond to different interactions or non-interactions between the ego 140 and the detected agent objects in the space around the ego 140. For instance, the ego computing device 141 can determine how the ego 140 may interact with the agent objects by determining identifications or classifications of the agent objects (e.g., pedestrians or vehicles), current locations of the agent objects, current locations of the agent objects relative to a target location of the task, current locations of the agent objects relative to the ego 140, and/or the current state of the agent objects (e.g., moving or not moving, a movement speed, a direction of movement, a size, etc.). The ego computing device 141 can determine such identifications or classifications and characteristics of the agent objects using machine learning techniques, using one or more functions, or by querying memory with sensor data generated regarding the agent objects. The ego computing device 141 can determine different interactions that may occur using the determined characteristics by using a machine learning model, by using one or more functions, or by querying memory. The ego computing device 141 can generate interaction nodes for interactions or non-interactions that may occur in attempting to accomplish the respective goals of the goal nodes. The ego computing device 141 can link the interaction nodes to the goal nodes to which the interaction nodes respectively depend.

The ego computing device 141 can determine node scores for the nodes of the hierarchical nodal graph 110d. The ego computing device 141 can do so using a function or machine learning techniques on data of the respective nodes. For example, the ego computing device 141 can input data of the individual interaction nodes into a machine learning model (e.g., a neural network, a support vector machine, a random forest, etc.) and execute the machine learning model for each interaction node. The machine learning model may output node scores for interaction nodes based on the executions. The ego computing device 141 can store the scores in the respective nodes for which the scores were generated.

The machine learning model may be trained to output node scores based on factors such as comfortability, physics-based constraints (e.g., a likelihood of a crash), a human-like discriminator (e.g., a likelihood that a human would perform the same action), and/or intervention likelihood. The machine learning model may be trained to do so, for example, using labeling techniques that indicate scores for the individual factors. The machine learning model may be trained to aggregate the scores for individual nodes to generate node scores for nodes. In some cases, multiple machine learning models may be used to generate scores for separate factors for each node of the hierarchical data structure.

The ego computing device 141 can expand the hierarchical nodal graph 110d over time. The ego computing device 141 can do so based on the scores of the nodes of the hierarchical nodal graph 110d. For example, the ego computing device 141 can identify any interaction nodes with a node score (e.g., at least one node score) that is less than a threshold. The ego computing device 141 may determine not to expand on the identified interaction nodes and insert a label into such interaction nodes or in memory accordingly or remove the low scoring nodes from the hierarchical nodal graph.

For interaction nodes with node scores that exceed the threshold, the ego computing device 141 can determine another interaction that depends from (e.g., is subsequent to or is reliant on) the transaction. In one example, if a pedestrian is crossing the road, an interaction of an initial interaction node may be to turn left after the pedestrian crosses the road. However, the ego computing device 141 may detect an oncoming vehicle that may be traveling in the same direction towards the space that the ego 140 would turn into. Accordingly, the ego computing device 141 may generate an interaction node that is linked to the initial interaction node corresponding to letting the pedestrian cross the road but that corresponds to letting the oncoming vehicle pass. The ego computing device 141 can generate another interaction node that is linked to the initial interaction node but that corresponds to passing in front of the oncoming vehicle. The ego computing device 141 can also generate interaction nodes for non-interactions with the pedestrian and the oncoming vehicle such as to wait for the pedestrian and oncoming vehicle to leave the space or to turn in a direction (e.g., turn right) in which the ego 140 would not interact with the pedestrian or the oncoming vehicle. The ego computing device 141 can repeat the node scoring and expansion process over time for any number of agent objects in the space around the ego 140.

The ego computing device 141 can generate trajectory scores for different trajectories outlined by the hierarchical nodal graph 110d. For example, the hierarchical nodal graph 110d can include one or more trajectories that each begin with a goal node and includes interaction nodes that are linked with each other to the goal node. The goal node may not be included in a trajectory, in some cases. The ego computing device 141 can determine a trajectory score for each trajectory based on the node scores of the nodes that make up the respective trajectories. The ego computing device 141 can retrieve the node scores from the respective nodes and perform a function (e.g., use an aggregation or summation technique, determine an average or weighted average, determine a median, etc.) or use machine learning techniques on the retrieved node scores to generate trajectory scores for the respective trajectories. In some cases, the ego computing device 141 can determine multiple trajectory scores for each trajectory based on the node scores for the different factors.

The ego computing device 141 can select a trajectory from the trajectories based on the trajectory scores. The ego computing device 141 can compare the trajectory scores together to determine a trajectory with a trajectory score that satisfies a condition. For example, the ego computing device 141 can identify a trajectory that corresponds with the highest trajectory score. In another example, the ego computing device 141 can determine a combination of trajectory scores for a trajectory that satisfies a condition (e.g., a combination of trajectory scores that are closest to the solution space for the factors of the combination) or that have the highest average, weighted average, sum, weighted sum, or median. The ego computing device 141 can control the ego 140 according to the identified or selected trajectory from the hierarchical nodal graph 110d.

In cases in which the analytics server 110a generates the hierarchical nodal graph 110d, the analytics server 110a can use similar techniques to the ego computing device 141 to generate the hierarchical nodal graph 110d. The analytics server 110a can do so using data from multiple egos 140 for different scenarios. In some cases, the analytics server 110a can remove (e.g., indicate or flag not to perform further calculations on or remove the nodes of the trajectories itself) trajectories from the hierarchical nodal graph 110d that are low scoring such that the egos 140 do not waste processing resources determining whether to implement the low scoring trajectories. The analytics server 110a can transmit the hierarchical nodal graph 110d to the egos 140 and the egos 140 can use the hierarchical nodal graph 110d by identifying interaction nodes and/or agent objects that correspond or match with the scenarios faced by the egos 140. The egos 140 may update the hierarchical nodal graph 110d with new interaction nodes and/or goal nodes, and thus new trajectories, based on the data the egos 140 collect for the individual scenarios.

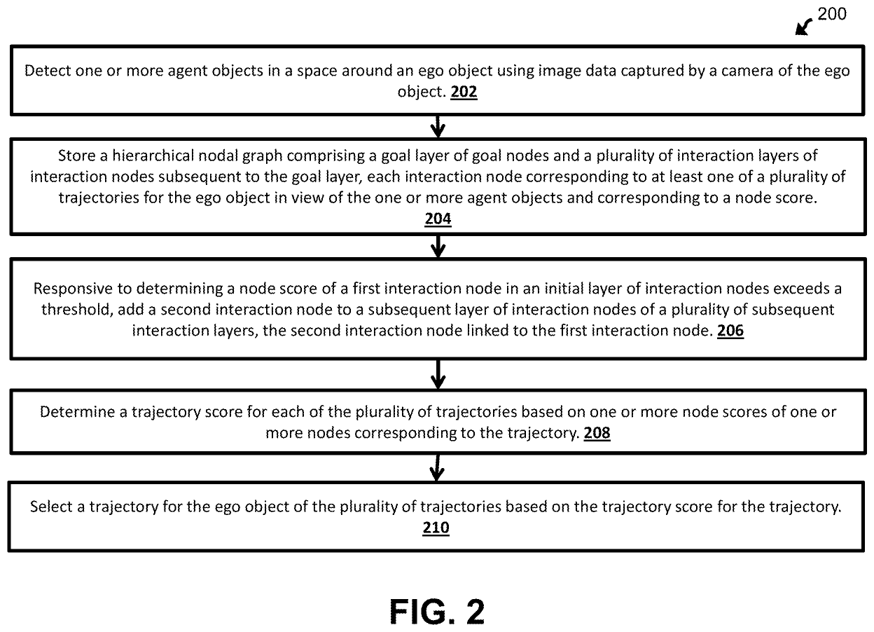

FIG. 2 illustrates a flow diagram of a method 200 executed in an AI-enabled, visual data analysis system, according to an embodiment. The method 200 may include steps 202-210. However, other embodiments may include additional or alternative steps or may omit one or more steps. The method 200 can be executed by an ego computing device (e.g., a computer similar to the ego computing devices 141 or a processor of the ego 140). However, one or more steps of the method 200 may be executed by any number of computing devices operating in the distributed computing system described in FIGS. 1A-C (e.g., the analytics server 110a). For instance, one or more computing devices of an ego may locally perform some or all of the steps described in FIG. 2.

Using the method 200, an ego computing device can implement a nodal hierarchical data structure for trajectory selection for an ego. To do so, the ego computing device can detect one or more agent objects (e.g., objects that are moving or may move) in the space or environment surrounding the ego (e.g., the ego object). The ego computing device can store a nodal data structure that includes goal nodes indicating goals for the ego to accomplish and/or interaction nodes that correspond to different potential interactions and/or non-interactions between the ego and the agent objects. The ego computing device can determine trajectory scores for different trajectories that follow the different permutations of the goal nodes and interaction nodes based on node scores of the nodes of the trajectories. The trajectory scores can correspond to comfortability, physics-based constraints, an intervention likelihood, and/or a discriminator (e.g., a human-like discriminator) of the respective trajectories. The ego computing device can compare the trajectory scores to identify the highest trajectory score. The ego computing device can select the trajectory with the highest trajectory score. The ego computing device can use the selected trajectory to control the ego.

At step 202, the ego computing device detects one or more agent objects in a space around the ego object. The ego computing device can detect the one or more agent objects using image data captured by a camera of the ego object. For example, the camera of the ego object can generate image data (e.g., images or video) of the environment surrounding the ego object over time and/or as the ego object is driving. The ego computing device may process the image data as the camera generates the image using object recognition techniques, such as by executing a machine learning model or an artificial intelligence model, to detect different objects in the image data. The ego computing device can identify the locations of detected objects relative to the ego object. In one example, the ego computing device can detect objects in the image data by detecting the occupancy of different voxels representing the space surrounding the ego object.

The ego computing device can determine types of the objects that the ego computing device detects. The types of objects can be stationary objects and agent objects, for example. The ego computing device can determine the types of the objects using a look-up technique in memory. For example, the ego computing device can detect the objects from the image data. Responsive to detecting the objects, the ego computing device can use a look-up in memory to match the detected objects with objects stored in memory. The objects stored in memory may have stored associations with a type of object. The ego computing device can determine the types of the detected objects based on matches with the objects stored in the memory. In some cases, a machine learning model or artificial intelligence model that the ego computing device executes to detect the objects can additionally determine the type of object. In some cases, the ego computing device can determine an identification or classification of the object (e.g., determine whether the object is a sign or a pedestrian) and determine the type of the object based on the determination (e.g., using a look-up in memory for the identification or classification). The ego computing device can detect objects and determine types of objects in any manner.

At step 204, the ego computing device stores a hierarchical nodal graph. The hierarchical nodal graph can include a goal layer comprising one or more goal nodes corresponding to goals for the ego object to accomplish. The hierarchical nodal graph can also include one or more interaction layers of interaction nodes subsequent to the goal layer. The interaction nodes can each correspond to interactions or non-interactions between the ego object and at least one of the agent objects (e.g., pedestrians, passing cars, etc.) that the ego computing device detects in the space surrounding the ego object. The goal nodes can correspond to goals for the ego to accomplish (e.g., turn to the far left lane, avoid hitting the pedestrian, etc.). Each node can be a data structure (e.g., a table or a Strapi model) that stores data specific to the node. The plurality of interaction layers can include an initial interaction layer of interaction nodes and/or one or more subsequent interaction layers of interaction nodes subsequent to the initial layer of interaction nodes.

The nodes in adjacent layers within the hierarchy of the hierarchical nodal graph can be linked (e.g., store an identifier of the linked node) with one or more nodes of the previous and/or subsequent layer within the hierarchy. For example, the goal nodes in the goal layer can each be linked to at least one interaction node in the initial interaction layer; individual interaction nodes in the initial interaction layer can be linked to at least one interaction node in the first subsequent interaction layer of the hierarchical nodal; etc. The links can indicate a dependency or a causality between the nodes. For example, an initial interaction node (e.g., an interaction node in an initial interaction layer) may be linked to a subsequent interaction node (e.g., an interaction node in a subsequent interaction layer). The initial interaction node may correspond to waiting for a pedestrian to pass before performing a left turn. The subsequent interaction node may be to wait for a passing vehicle to pass before performing a left turn. The subsequent interaction node may depend on the initial interaction node because the interaction of the subsequent interaction node may only be possible if the interaction of the initial interaction node occurs first. In some cases, the dependency may indicate a sequential nature of the interaction. For instance, the interaction of the subsequent interaction described above may occur after the interaction of the interaction node. The hierarchical nodal graph can include any number of interaction nodes in different interaction layers that are linked with interaction nodes in other interaction layers of the hierarchical nodal graph in this manner.

The links between goal nodes in the goal layer and interaction nodes in the initial interaction layer may have a similar dependency as the dependency between interaction nodes. For example, a goal may be to perform a far left turn. Performing the far left turn may cause different interactions with different agent objects (e.g., a vehicle or pedestrians) to be possible than if the goal were to be to make a turn in another direction. Accordingly, interaction nodes linked with the goal node for making a left turn may be in view of agent objects that may be impacted by or affect whether and/or how the ego object makes the left turn.

Interaction nodes can also correspond to the lack of an interaction with one or more other agent objects. For example, a goal node may correspond to a goal of performing a left turn. The ego computing device can detect pedestrians in the lane for the turn and another vehicle approaching from the right. There can be interaction nodes in the hierarchical nodal graph for inactions by the ego object such as to turn right to avoid the pedestrians and the car or to stay still until the path is clear. Each such interaction node can be an interaction node in the hierarchical nodal graph.

In some cases, the ego computing device can generate the hierarchical nodal graph. The ego computing device can generate the hierarchical node responsive to determining at least one task for the ego object to accomplish (e.g., determining to make a left turn to follow a pre-determined or configured path). The task can be a goal. The ego computing device can generate the hierarchical nodal graph further responsive to detecting one or more agent objects in the space around the ego object.

For example, responsive to determining to accomplish a goal and/or detecting one or more agent objects in the space around the ego objects, the ego computing device can generate one or more goal nodes of a goal layer of the hierarchical nodal graph. The ego computing device can generate the one or more goal nodes by querying memory for different goals for the ego computing device to accomplish based on the task. Examples of such goals for a left turn task may be to avoid hitting any pedestrians, avoid hitting any other vehicles, make sure the turn is not too sharp, ensure the speed of the ego object remains below a threshold, etc. The ego computing device can generate the one or more goal nodes by storing or allocating data structures for the individual goal nodes in memory. The ego computing device can populate the data structures for the different goal nodes with information about the goals of the respective goal nodes, such as an identification of the goal and any metadata regarding the goal (e.g., a node score for the goal node).

The ego computing device can generate one or more interaction nodes for each of one or more interaction layers of the hierarchical nodal graph. The ego computing device can generate the interaction nodes based on potential interactions and/or non-interactions that the ego computing device determines between the ego object and the detected agent objects. The ego computing device can determine such interactions and/or non-interactions for each of the goal nodes. For instance, for a goal node associated with a goal of turning left into a far lane, the ego computing device can determine potential interactions or non-interactions with a pedestrian crossing the street in the lane and another vehicle approaching in that same lane. The ego computing device can determine the potential interactions by querying memory using the locations and/or the identifications of what the objects are and identify potential interactions that correspond with the scenario, for example. In some cases, the ego computing device can execute a machine learning model (e.g., a neural network, a support vector machine, a random forest, etc.) to identify the different potential interactions. The ego computing device can similarly query memory or execute a machine learning model to determine which agent objects may be involved in potential interactions for the ego to accomplish the goal. In some cases, the ego computing device similarly determines potential interactions with the identified agent objects without first determining which agent objects may be involved in potential interactions with the ego object for performance of the goal. The ego computing device can generate interaction nodes linking the interaction nodes to the goal node in the hierarchical nodal graph. The ego computing device can include an identification of the interaction with metadata regarding the interaction (e.g., a type of interaction, a node score for the interaction node of the interaction, speed of one or each of the objects of the interaction node, etc.) in each interaction node linked to the goal node. The ego computing device can link any number of interaction nodes to a goal node.

The ego computing device can sequentially link interaction nodes of different interaction layers that depend on each other. For instance, one interaction with an agent object may only be able to occur subsequent to another interaction with the same agent object or a different agent object. Accordingly, the ego computing device may link the subsequent interaction with the earlier interaction in separate interaction layers of the hierarchical nodal graph. For example, the ego object may let a pedestrian cross the street and then let another vehicle pass the ego object. The ego computing device may link an interaction node for letting the pedestrian pass to an interaction node for letting the vehicle pass in adjacent layers of the hierarchical nodal graph. The ego computing device can link any number of interaction nodes to individual interaction nodes in any number of layers. Thus, the ego computing device can generate a hierarchical nodal graph in view of different interactions or non-interactions that may occur and goals for the ego object to accomplish.

In some cases, the hierarchical nodal graph may be generated by a server (e.g., the analytics server 110a) and deployed on the ego object. For example, the server can receive image data from different ego objects in autonomous driving scenarios that involve different agent objects around the ego objects within the scenarios. The server can receive the data of the autonomous driving scenarios and generate a hierarchical nodal graph (e.g., a single hierarchical nodal graph) that covers each of the scenarios with goal nodes for goals of the scenarios and interaction nodes for interactions and non-interactions with the agent objects of the scenarios. The server can generate the hierarchical nodal graph by adding goal nodes and interaction nodes for the different scenarios as the server receives data for the scenarios from the ego objects. The server may avoid duplicates of goal nodes or interaction nodes, for example, by, before adding a new node to the hierarchical nodal graph, analyzing the hierarchical nodal graph for nodes of the same type (e.g., goal node or interaction node) and only adding a new node responsive to determining the same node or a similar node (e.g., a node with metadata similar above a threshold) is not already present in the hierarchical nodal graph. In some cases, such as to preserve processing resources, the analysis may only be done on nodes in the same branch of nodes (e.g., nodes that are linked to each other) to which the node would be added. The server can generate such a nodal hierarchical nodal graph over time. The server can deploy (e.g., a transmit, such as in a binary file to individual ego objects for use) the hierarchical nodal graph (e.g., as a master hierarchical nodal graph) to ego objects to use for autonomous driving as described herein. After deployment, the server can continue to receive data and update the hierarchical nodal graph based on the received data. The server can deploy updated versions of the hierarchical nodal graph at set intervals, responsive to receiving an input to do so, or responsive to determining any other condition is satisfied.

The ego computing device can generate node scores for the nodes of the hierarchical nodal graph. The ego computing device can generate such node scores for interaction nodes and goal nodes. The ego computing device can generate node scores for the individual nodes using an analytical protocol (e.g., a function, algorithm, machine learning model, or artificial intelligence model configured to generate node scores for nodes). For example, the ego computing device can generate a node score for a node by retrieving the data in the data structure of the node and executing a neural network trained to generate scores for nodes. The neural network can output node scores for the individual nodes based on the data within the respective nodes. In another example, the ego computing device can generate node scores by executing a function (e.g., a sum, median, average, weighted sum, weighted average, etc.) on values within the nodes. The ego computing device can generate node scores for nodes in any manner.

In some cases, the node scores can correspond to factors such as comfortability, physics-based constraints (e.g., collision checks), intervention likelihood (e.g., a likelihood that a human will intervene), and/or a human-like discriminator (e.g., score indicating that the same decision would be performed by a human driver). For example, when the neural network (or another machine learning model) is trained, the neural network may be trained to generate scores that correlate with each or a subset of these factors, where higher values of the individual factors can correspond to higher scores and lower levels of the factors can correspond to lower scores. Accordingly, when the neural network generates the scores for the nodes, the neural network may simulate determining scores that represent or correspond with the factors. In another example, different machine learning models (e.g., neural networks) or functions can be trained or configured to generate scores for different factors. In such cases, the machine learning models or functions can be configured to process specific types of data or the same types of data from the respective nodes. For each node, the different machine learning models or functions can output scores for the respective factors. A different machine learning model or function can process the scores of the factors to generate node scores for the nodes. The scores for the factors can be node scores. The ego computing device can store any node scores generated for nodes in the respective nodes themselves. The server can similarly generate and store node scores in nodes of a hierarchical nodal graph that the server generates.

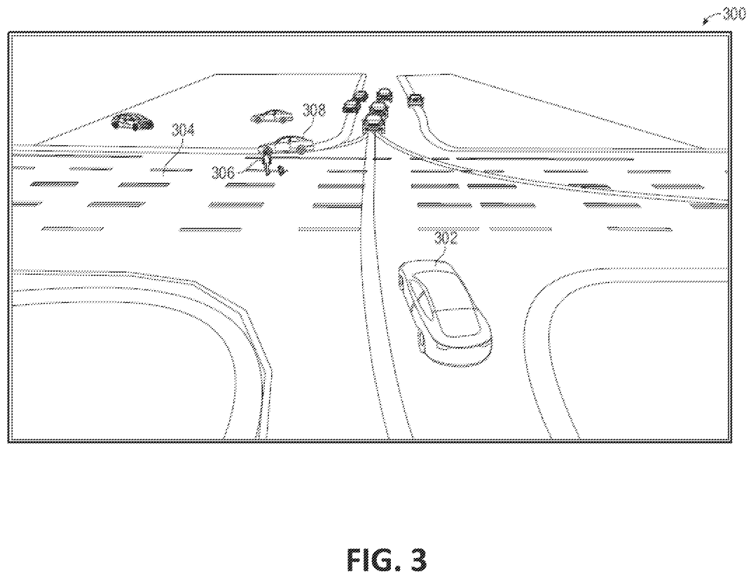

In a non-limiting example, referring now to FIG. 3, a roadway scenario 300 is depicted. The roadway scenario 300 includes an ego object 302 attempting to turn left into a lane 304 of a crossing road. In doing so, the ego computing device of the ego object 302 can collect image data of the environment surrounding the ego object 302. From the image data, the ego computing device can detect the lane 304 and agent objects 306 and 308. The agent object 306 may be a pedestrian crossing the road across the lane 304. The agent object 308 may be a vehicle making a right turn behind the pedestrian onto the same road that the ego object 302 is attempting to turn onto. The ego computing device can generate a hierarchical nodal graph based on potential interactions with the agent objects 306 and 308.

Referring again to FIG. 2, at step 206, the ego computing device adds an interaction node (e.g., a second interaction node) to a subsequent layer of interaction nodes of the hierarchical nodal graph. The ego computing device can perform the step 206 when generating the hierarchical nodal graph in step 204, for example, or subsequent to generating the hierarchical nodal graph to update the hierarchical nodal graph. The ego computing device can add the interaction node responsive to detecting or determining an interaction with an agent node in the space surrounding the hierarchical nodal graph. In one example, the ego computing device can add the interaction node after generating the hierarchical nodal graph and detecting a new agent node in the space surrounding the ego object. The ego computing device can add the interaction node by determining the interaction node or interaction nodes from which the new interaction node depends (e.g., based on whether the interaction of the new interaction node will occur subsequent to or based on the interaction of the previous interaction node). The ego computing device may add the interaction node to the hierarchical nodal graph in the interaction layer following the interaction layer in which the previous interaction node is located.

The ego computing device can add the interaction node in response to determining a node score for the interaction node exceeds a threshold. For example, prior to adding the interaction node to the hierarchical nodal graph, the ego computing device can determine a node score for the interaction node. The ego computing device can do so using the systems and methods described herein based on data in the interaction node. The ego computing device can compare the node score to a threshold (e.g., a defined threshold). Responsive to determining the node score exceeds the threshold, the ego computing device can add the interaction node to the hierarchical nodal graph. Otherwise, the ego computing device can discard the interaction node (e.g., remove the interaction node from memory or otherwise not add the interaction node to the hierarchical nodal graph) or add the interaction node to the hierarchical nodal graph with a flag that restricts linking any further interaction nodes from the interaction node. In some cases, the ego computing device can generate node scores for different factors for the interaction node and compare the node scores to a threshold (e.g., the same threshold or different thresholds for each factor). The ego computing device can add the interaction node to the hierarchical nodal graph responsive to determining a number or combination (e.g., a defined number or combination) of scores exceed a threshold. Otherwise, the ego computing device can discard the interaction node. The server can similarly add interaction nodes to the hierarchical nodal graph that the server generates.

In some cases, the ego computing device can remove nodes from the hierarchical nodal graph. For example, the ego computing device can identify the node scores of different nodes of the hierarchical nodal graph. The ego computing device can compare the node scores to a threshold. Responsive to determining a node score for a node is less than the threshold, the ego computing device can remove the node from the hierarchical nodal graph. In removing the node from the hierarchical nodal graph, the ego computing device can identify any nodes that depended from the removed node in the hierarchical nodal graph. The ego computing device can remove any such nodes in some cases further responsive to determining the respective removed nodes do not depend from another node (e.g., a node in a previous interaction layer or goal layer) in the hierarchical nodal graph. In doing so, the ego computing device can remove undesirable nodes and branches from the hierarchical nodal graph that an administrator may not ever want to be selected as part of a selected trajectory or that may cause a trajectory including the removed node to never be selected. Thus, the ego computing device can avoid using processing resources required to store the removed nodes or removed branches in hierarchical nodal graph storage and/or trajectory selection.

In another example, the ego computing device can maintain a defined size of the hierarchical nodal graph. For example, when adding the interaction node to the hierarchical nodal graph, the ego computing device may determine whether adding the node would cause the hierarchical nodal graph to have a size (e.g., a number of nodes) that exceeds a threshold. The ego computing device can instantiate and increment a counter for each node (e.g., each interaction node) of the hierarchical nodal graph and increment the counter for the node being added. Responsive to determining the new node causes or will cause the hierarchical nodal graph to have a size exceeding the threshold, the ego computing device can identify the node scores of the different nodes (e.g., different interaction nodes) and remove an interaction node with the lowest interaction score or an interaction node with a node score below a threshold, including any nodes that depend from the selected node. The ego computing device can decrement the counter according to the number of nodes that were removed. Accordingly, the ego computing device can maintain a constant or consistent size to maintain the processing requirements of maintaining the hierarchical nodal graph and avoiding spikes in processing as the ego computing device detects further agent objects.

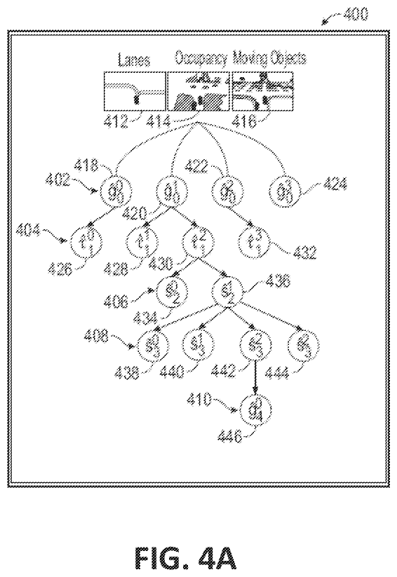

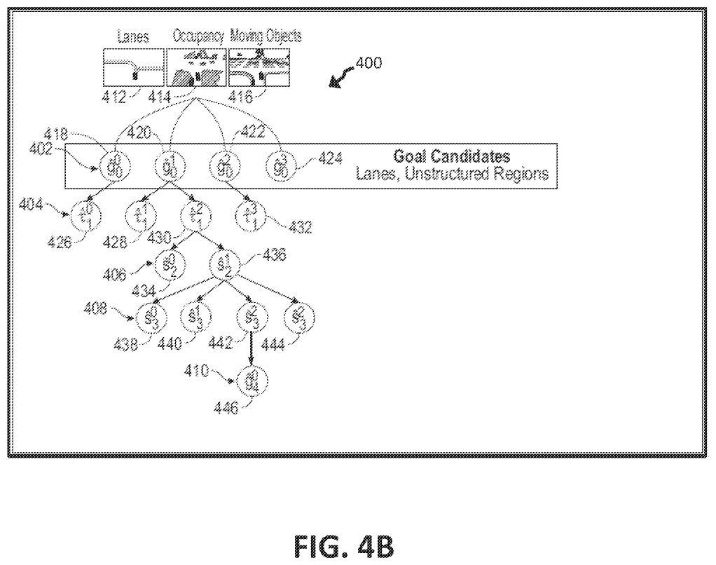

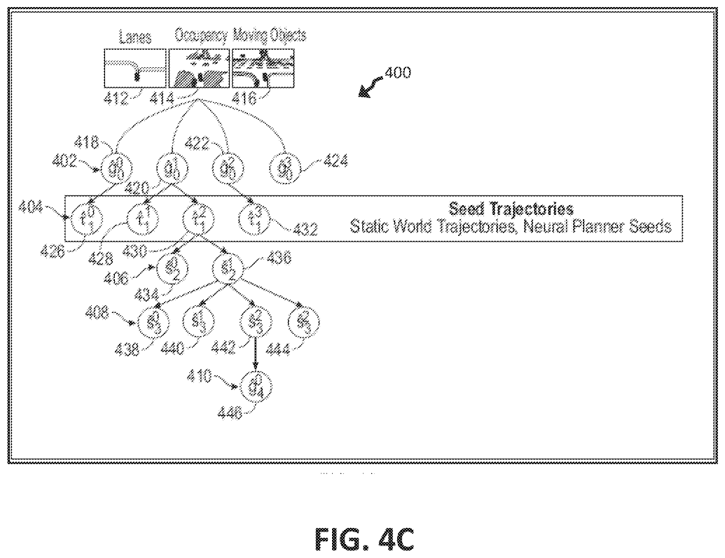

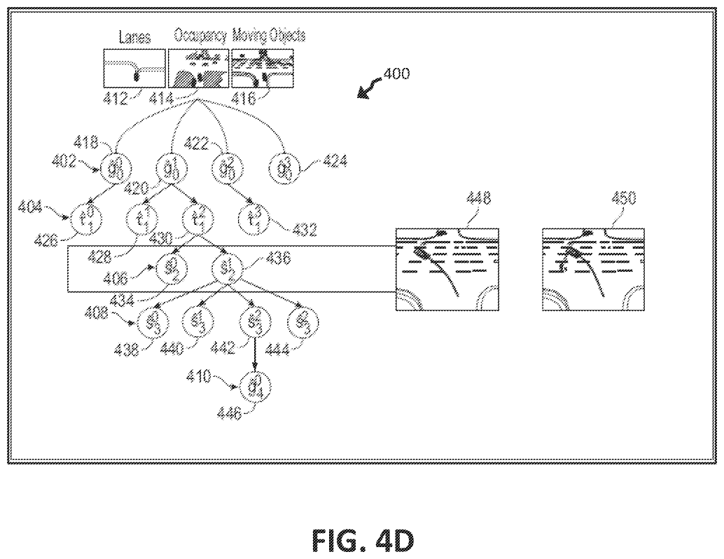

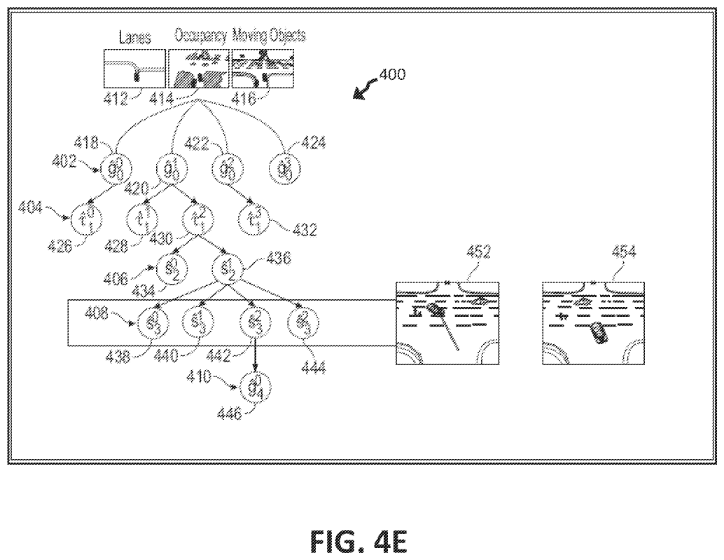

In a non-limiting example, with reference to FIGS. 4A-4F, the ego computing device can generate a hierarchical nodal graph 400 based on detected agent objects in the environment surrounding the ego object. The hierarchical nodal graph 400 can include a goal layer 402, a trajectory layer 404, an interaction layer 406, an interaction layer 408, and a goal layer 410. The interaction layer 406 can be an initial interaction layer. The interaction layer 408 can be a subsequent interaction layer. The ego computing device can generate the hierarchical nodal graph 400 based on lanes 412, occupancy 414, and moving objects (e.g., agent objects) 416 that the ego computing device detects from image data from a camera of the ego object.

To generate the hierarchical nodal graph 400, the ego computing device can use a step-based approach. For example, the ego computing device can first generate goal nodes 418, 420, 422, and 424 and add goal nodes 418, 420, 422, and 424 to the hierarchical nodal graph 400. The ego computing device can generate node scores for each of the goal nodes 418, 420, 422, and 424. The ego computing device can compare the node scores for the goal nodes 418, 420, 422, and 424 to a threshold. The ego computing device can determine that the goal nodes for each of the goal nodes 418, 420, and 422 but not the goal node 424. Accordingly, the ego computing device can generate trajectory nodes 426, 428, 430, and 432 that are respectively linked to the different goal nodes 418, 420, and 422, but not the goal node 424 because the node score for the goal node 424 is below the threshold. The trajectory nodes and trajectory layer may or may not be included in hierarchical data structures that ego computing devices create when implementing the systems and methods described herein. The trajectory nodes 426, 428, 430, and 432 can correspond to different motions, paths, or trajectories that the ego object can take to accomplish a goal of the goal nodes 418, 420, 422 to which the trajectory nodes 426, 428, 430, and 432 are linked or depend. The trajectory nodes can store data (e.g., movement speed and location) of the respective trajectories in the trajectory nodes 426, 428, 430, and 432.

The ego computing device can generate node scores for the trajectory nodes 426, 428, 430, and 432 using a function or machine learning model on the data in the trajectory nodes 426, 428, 430, and 432. The ego computing device can compare the node scores of the trajectory nodes 426, 428, 430, and 432 to a threshold. The ego computing device can identify trajectory nodes that exceed the threshold and generate interaction nodes of an initial interaction layer based on the identified trajectory nodes. For example, the ego computing device can determine the node score for the trajectory node 430 exceeds the threshold and generate interaction nodes 434 and 436 that are linked to and/or depend from the trajectory node 430 in response to the determination. The interaction for the interaction node 434 can be to drive in front of a pedestrian, as illustrated in an image 448. The interaction for the interaction node 436 can be to let the pedestrian pass (e.g., yield to the pedestrian) and turn left after the pedestrian, as illustrated in an image 450. The ego computing device can determine node scores for the interaction nodes 434 and 436 and compare the node scores to a threshold (e.g., the same threshold as the threshold used for the node scores of the trajectory nodes 426, 428, 430, and 432 or a different threshold). The ego computing device can determine the node score of the interaction node 436 exceeds the threshold but the node score of the interaction node 434 does not. Accordingly, the ego computing device may not link any further interaction nodes to the interaction node 434 but may add interaction nodes 440, 442, and 442 to the hierarchical nodal graph 400 depending from (e.g., linked to) the interaction node 436. The interaction for the interaction node 440 can be to drive behind a pedestrian per the interaction of the interaction node 436 but in front of another vehicle, as illustrated in an image 452. The interaction for the interaction node 442 can be to let the pedestrian and the vehicle pass (e.g., yield to the pedestrian and the vehicle) and the turn left, as illustrated in an image 454. The ego computing device can repeat this process for any number of interaction nodes and/or interaction layers.

In some cases, the ego computing device can generate a goal node that depends from an interaction node. For example, the ego computing device can generate a goal node 446 that depends from the interaction node 442 if the ego computing device determines the occurrence of the interaction of the interaction node 442 would trigger another goal. The ego computing device can make such a determination by determining the data of the interaction node 442 satisfies a condition stored in memory. In one example, the interaction may be to complete a left turn after letting the agent objects pass the ego object. The ego computing device can analyze the new state after the interaction node 442 and generate the goal node 446 to drive straight in the new lane that the ego object is driving in. The new goal can correspond to a new trajectory or initiate a repetition the method 200 to generate a hierarchical nodal graph to select a trajectory.

Referring again to FIG. 2, at step 208, the ego computing device determines a trajectory score for each of a plurality of trajectories of the hierarchical nodal graph. A trajectory can be or include a goal node and one or more interaction nodes that are linked to each other between layers of interaction nodes. For example, a trajectory may include nodes corresponding to a scenario in which the ego object has a goal of turning left and the ego computing device detects a crossing pedestrian and another vehicle passing by. A trajectory may involve the nodes corresponding to turning left after the pedestrian crosses the road and the vehicle passes by. Another trajectory in the scenario may be to turn left in front of the pedestrian. Another trajectory in the scenario may be to turn left behind the pedestrian but before the vehicle passes by. Another trajectory may be to avoid the pedestrian and passing vehicle altogether and turn right instead. There may be any number of trajectories that correspond to nodes of the hierarchical nodal graph. The ego computing device can determine trajectory scores of the trajectories as a function of or otherwise based on the node scores of the nodes of trajectories. For example, the ego computing device can execute a function (e.g., a sum or aggregation technique, median, average, weighted sum, weighted average, etc.) or a machine learning model on the node scores of nodes of each trajectory to generate trajectory scores for the respective trajectories.

In some cases, the ego computing device can determine multiple trajectory scores for individual trajectories. The different trajectory scores can correspond to different factors (e.g., physics-based constraints (e.g., collision checks), comfort analysis, intervention likelihood, human-like discriminator, etc.). The ego computing device can determine the trajectory scores for the factors using a function or machine learning model as described above on node scores for the respective factors. In some cases, the ego computing device can combine the different trajectory scores for a trajectory to generate a single trajectory score, such as by using a function or machine learning model to do so.

In some cases, the ego computing device can remove entire trajectories from the hierarchical nodal graph. The ego computing device can remove individual trajectories from the hierarchical nodal graph by storing a flag or indication in memory indicating not to use the trajectory or by deleting the nodes of the trajectory. The ego computing device can remove a trajectory responsive to determining the trajectory score for the trajectory is below a threshold or responsive to determining the trajectory score satisfies another condition, such as is the lowest trajectory score of the trajectories of the hierarchical nodal graph. In doing so, the ego computing device may reduce the size of the hierarchical nodal graph or otherwise ensure that the processing resources are not wasted evaluating low-scoring trajectories.

At step 210, the ego computing device selects a trajectory for the ego object. The ego computing device can select the trajectory for the ego object based on the trajectory scores of the trajectories the ego computing device determined from the hierarchical nodal graph. The ego object can select the trajectory responsive to determining the trajectory score for the trajectory satisfies a condition. In one example, the ego object can select the trajectory responsive to determining the trajectory score for the trajectory is the highest of the trajectory scores that the ego computing device determined. Responsive to selecting the trajectory, the ego computing device can control the ego object according to the selected trajectory.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitates the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
detecting, by a processor, one or more agent objects in a space around an ego object using image data captured by a camera of the ego object;
storing, by the processor, a hierarchical nodal graph comprising:
a goal layer comprising one or more goal nodes corresponding to goals for the ego object to accomplish;
a plurality of interaction layers of interaction nodes subsequent to the goal layer, each interaction node corresponding to at least one of a plurality of trajectories for the ego object in view of the one or more agent objects and corresponding to a node score, the plurality of interaction layers comprising an initial interaction layer of interaction nodes and a plurality of subsequent interaction layers of interaction nodes subsequent to the initial interaction layer of interaction nodes, wherein each interaction node in the plurality of subsequent interaction layers depends from at least one interaction node in a previous interaction layer of the plurality of interaction layers;
responsive to determining a node score of a first interaction node in the initial interaction layer of interaction nodes exceeds a threshold, adding, by the processor, a second interaction node to a subsequent interaction layer of interaction nodes of the plurality of subsequent interaction layers, the second interaction node linked to the first interaction node;
determining, by the processor, a trajectory score for each of the plurality of trajectories based on one or more node scores of one or more nodes corresponding to the trajectory; and
selecting, by the processor, a trajectory of the plurality of trajectories for the ego object based on the trajectory score for the trajectory.

2. The method of claim 1, further comprising:
controlling, by the processor, the ego object according to the selected trajectory.

3. The method of claim 1, wherein determining the trajectory score for the trajectory comprises aggregating, by the processor, the one or more node scores of the one or more nodes of the trajectory.

4. The method of claim 1, wherein selecting the trajectory comprises selecting, by the processor, the trajectory responsive to determining the trajectory score for the trajectory is higher than trajectory scores of other trajectories of the plurality of trajectories.

5. The method of claim 1, further comprising:
executing, by the processor, a neural network to determine the node score for each interaction node of the hierarchical nodal graph.

6. The method of claim 1, wherein the node score for each interaction node corresponds to a comfortability associated with the interaction node.

7. The method of claim 1, wherein the node score for each interaction node corresponds to a comfortability associated with the interaction node and a likelihood of intervention associated with the interaction node.

8. The method of claim 1, further comprising:
generating, by the processor, the hierarchical nodal graph responsive to detecting the one or more agent objects in the space around the ego object using image data captured by a camera of the ego object.

9. The method of claim 1, further comprising:
executing, by the processor, an analytical protocol to determine the node score for each interaction node of the hierarchical nodal graph;
comparing, by the processor, the node scores to a threshold; and
removing, by the processor, each interaction node of the hierarchical nodal graph from the hierarchical nodal graph that corresponds to a node score that is less than the threshold.

10. The method of claim 1, further comprising:
responsive to determining that adding the second interaction node to the subsequent layer of interaction nodes of the plurality of subsequent layers causes a number of nodes of the hierarchical nodal graph to exceed a threshold, removing, by the processor, a third node from the hierarchical nodal graph based on a node score for the third node.

11. An ego object comprising:
a camera;
a processor; and
a non-transitory computer-readable medium configured to be executed by the processor, wherein the processor is configured to:
detect, one or more agent objects in a space around an ego object using image data captured by the camera;
store a hierarchical nodal graph comprising:
a goal layer comprising one or more goal nodes corresponding to goals for the ego object to accomplish;
a plurality of interaction layers of interaction nodes subsequent to the goal layer, each interaction node corresponding to at least one of a plurality of trajectories for the ego object in view of the one or more agent objects and corresponding to a node score, the plurality of interaction layers comprising an initial interaction layer of interaction nodes and a plurality of subsequent interaction layers of interaction nodes subsequent to the initial interaction layer of interaction nodes, wherein each interaction node in the plurality of subsequent interaction layers depends from at least one interaction node in a previous interaction layer of the plurality of interaction layers;
responsive to determining a node score of a first interaction node in the initial interaction layer of interaction nodes exceeds a threshold, add a second interaction node to a subsequent interaction layer of interaction nodes of the plurality of subsequent interaction layers, the second interaction node linked to the first interaction node;
determine a trajectory score for each of the plurality of trajectories based on one or more node scores of one or more nodes corresponding to the trajectory; and
select a trajectory of the plurality of trajectories for the ego object based on the trajectory score for the trajectory.

12. The ego object of claim 11, wherein the processor is further configured to:
control the ego object according to the selected trajectory.

13. The ego object of claim 11, wherein the processor is configured to determine the trajectory score for the trajectory by aggregating the one or more node scores of the one or more nodes of the trajectory.

14. The ego object of claim 11, wherein the processor is configured to select the trajectory by selecting the trajectory responsive to determining the trajectory score for the trajectory is higher than trajectory scores of other trajectories of the plurality of trajectories.

15. The ego object of claim 11, wherein the processor is further configured to:
execute a neural network to determine the node score for each interaction node of the hierarchical nodal graph.

16. The ego object of claim 11, wherein the node score for each interaction node corresponds to a comfortability associated with the interaction node.

17. The ego object of claim 11, wherein the node score for each interaction node corresponds to a comfortability associated with the interaction node and a likelihood of intervention associated with the interaction node.

18. The ego object of claim 11, wherein the processor is further configured to:
generate the hierarchical nodal graph responsive to detecting the one or more agent objects in the space around the ego object using image data captured by a camera of the ego object.

19. The ego object of claim 11, wherein the processor is further configured to:
execute an analytical protocol to determine the node score for each interaction node of the hierarchical nodal graph;
compare the node scores to a threshold; and
remove each interaction node of the hierarchical nodal graph from the hierarchical nodal graph that corresponds to a node score that is less than the threshold.

20. The ego object of claim 11, wherein the processor is further configured to:
responsive to determining that adding the second interaction node to the subsequent layer of interaction nodes of the plurality of subsequent layers causes a number of nodes of the hierarchical nodal graph to exceed a threshold, remove a third node from the hierarchical nodal graph based on a node score for the third node.
